(19) United States
(12) Patent Application Publication
(10) Pub. No.: US 2004/0249869 A1
(43) Pub. Date: Dec. 9, 2004

(54) Method and system for restarting a replica of a database

(76) Inventor: Kenneth Oksanen, Helsinki (FI)

Correspondence Address: Robert M Bauer, Brown Raysman Millstein Felder & Steiner, 900 Third Avenue, New York, NY, 10022, US

(21) Appl. No.: 10/482,612

(22) PCT Filed: Jun. 25, 2001
(86) PCT No.: PCT/EP01/07195

(51) Int. Cl. G06F 17/30

(52) U.S. Cl. 707/204

(57) ABSTRACT

A method for restarting a replica of a database comprises the steps of: sending the transient metadata of an active replica to the replica restarting and sending the contents of the cells which are collected in said active replica to the replica restarting. Further, a method for synchronization of a few replicas as well as an apparatus for processing said methods as described.

### FIELD OF THE INVENTION

The present invention relates to a method and system for restarting a replica of a database, and more specially to a method and system for managing replicas of this database.

### BACKGROUND OF THE INVENTION

A known database consists of a large amount of data which is stored in a persistent memory such as a harddisk medium. If the structure of the database given by pointers stored in the cells of the database and pointers stored in the root block of the database, is only stored in the persistent memory, every access onto data consumes a large amount of IO (input/output) time, for example for the frequent disk access. Hence, at least the structure of the database given by said pointers is stored in a fast accessible memory, for example a dynamic random access memory. In this memory storage data is transiently stored.

It is possible to replicate the database image on two or more computers so that should one computer crash, the other will take over and continue the work without significant interruption. Since active replicas can be run on entirely different computing platforms with different processors, motherboards and operating systems and since the application processing the database can be compiled for them with different compilers and linked with different libraries, replication can be used to mask away bugs in the computing platforms and achieve extremely high levels of reliability.

In case a replica of the database crashes, the known database halts the application, deletes the crashed replication and copies the whole image of another active replication over the replication crashed. But copying the whole database consumes a lot of transmission time so that the application is halted for a long time until it can be continued. On the other hand, when multiple replicas of the database are run on a lot of different computers the probability of an error, because of a hardware failure, a disk IO error, a power failure or some other reason, increases, and hence the down-time of the database is increased.

If a database crashes due to an internal error, the origin of this error may have been formerly spread over to other replicas of the database. Hence, the known database has the disadvantage that after the first replica has been crashed, probably some other or all replicas of the database will crash thereafter.

### SUMMARY OF THE INVENTION

It is a general object of the invention to increase the durability of a replicated database system.

It is another object of the present invention to decrease the down-time of the database after a crash of a replica.

A further object of the present Invention is to prevent the spread of an error of a replica over the database system.

This objects are achieved by a method for restarting a replica of a database comprising the steps of:

sending the transient metadata of an active replica to the replica restarting and

sending the contents of cells which are collected in said active replica to said replica restarting.

Furthermore, the above objects are achieved by a method for managing replicas of database comprising the steps of:

computing for each replica a checksum,

comparing the checksums computed, and

synchronizing the replicas of the database.

Also, the objects are achieved by a system for storing and processing a database comprising:

a first storage means for storing a first replica of said database and at least a

second storage means for storing a second replica of said database, whereby that first and second storage means are connected to interchange data, and the system further comprises a restarting means for restarting said first or second replica after it has been silenced, whereby said restarting means sends the transient metadata of the active one of said first and second replicas to the silenced one and copies for each collected cell the pages of the active replica storage memory to pages of the silenced replica storage means arranged according to said metadata.

Furthermore, the objects are achieved by a system for storing and processing at least two replicas of a database comprising:

a checksum computing means for computing a checksum for each replica,

a comparison means for comparing said checksums computed, and

a synchronization means for synchronize said replica with regard to their check sums.

The present invention has the advantage, that for each replica a checksum is computed to detect a possible error before it leads to the crash of one of the replicas. If a difference in the check sums of the replicas is detected, one or more replicas can be silenced, whereby at least one replica must remain active to process transaction requests. An active replica receives all transaction request and performs all the operation specified in them. On the other hand, a passive replica executes no transactions but updates its database image from active replicas, for example, at the end of each commit group. A non-passive but silenced replica can still receive and execute all that transaction requests as the primary replica, but it would remain quiet and not send any replies to the clients. When a non-active replica Is restarted, the transient metadata of an active replica is sent to the replica restarting, whereby the contents of the transient metadata, for example, is related to generations, pages and the root block. Therefore, in the restarting replica this has the effect of allocating the same generations and assigning the same pages to them as in the active replica, but with the distinction that the pages themselves are empty. Therefore, the structure of the database can be derived with little transaction time.

Whenever the active replica collects cells, the contents of the cells collected are sent to the replica restarting so that the replica restarting can fill the empty pages of the generations. For example, the active replica can send the pages of a generation comprising one or more cells to the restarting replica, whenever it writes them to disk. Hence, the restarting replica can place the pages in the same generation in the same position in its own memory, can scan the cells for references to older generations and updates their remsets accordingly, and finally write the pages to its own disk.

On the other hand, when synchronizing the replicas of the database, In some cases, for example when the active replica crashes, it is better to continue with the silenced one.

According to an advantageous development, the checksums are computed as checksums of the data in the root block. and/or the previously collected youngest generation, and possibly as the checksum of the mature generations collected in the beginning of the commit group and/or some transient meter data. According to an advantageous development, in case the check sums of active replicas differ, a replica with a checksum different from the most frequent checksum is deleted and recovered in total. Hence the minority opinion of the correct check sum is refreshed.

According to another advantageous development, when said check sums are computed before the end of a group commit, in case of at least two different check sums the group commit is repeated. This can be achieved simply by making a backup of the root block before starting the commit group and restoring when aborting the group commit. Neither replica needs to be restarted, and the transaction can be reattempted without significant delay. Should the failure has been caused by a transient error, such as a voltage peak, an alpha particle in the processor or cache, or temporary noise in the system bus, the next commit group may well succeed. But should also the next commit groups fail, one of the other options must be used.

According to a further advantageous development, In case of at least two different checksums, the regular processing of the database is halted and the database is checked. In this option a number of checks in the database can be performed: a check, if all cells pass various cell type dependent consistency checks; a check, whether all pointers refer to valid cells in the same or older generations; a test, whether the pool of free pages corresponds to the pages known to be in use by enumerating all pages in all mature generations. Also, a system administrator can be informed. Hence the reliability of the database is further increased.

According to a further advantageous development, in case of different checksums, a replica is chosen, said replica chosen is silenced, whereby at least one replica remains active as a primary replica, in case said active replica fails, said silenced replica becomes the new primary replica, and in case both said primary and silenced replica begin to agree on check sums the silenced replica is restarted.

For example, if the silenced replica crashes or fails a consistency check, the silenced replica was in error and is restarted. When the silenced replica continues to disagree on the checksums with the primary replica, but neither seems to crash or fail a consistency check, it can be assumed that either replica has performed a detectable, but non-fatal failure, such as a minute rounding error. Since the clients have been receiving answers from the primary replica during the quaranteen, the silenced replica is restarted.

When neither replica crashes, and the replicas eventually begin to agree on checksums, that means the replicas have been converged for example because the differring cell has become garbage, it is advantageous to reduce the quaranteen time for the near future, so that in case the checksums again begin to differ, the cause of the difference is not vanished and either replica better be restarted.

In case the silenced replica takes over and becomes the new primary replica due to a crash or fail of a consistency check of the primary replica, the clients may have gotten incorrect replies or may have lost transaction, but nevertheless the restarted replica is still transaction-consistent and comprises a relatively up-to-date database image rather than a corrupted one.

### BRIEF DESCRIPTION OF THE DRAWINGS

In the following, the present invention will be described in greater detail based on preferred embodiments with reference to the accompanying drawing figures, in which:

FIG. 1-3 show a restart major collection step according to a preferred embodiment of the invention;

FIG. 4 shows a restart first generation collection according to the preferred embodiment;

FIGS. 5 and 6 show a procedure for a recovery scan according to the preferred embodiment;

FIG. 7 shows a procedure for a recovery copy according to a preferred embodiment; and

FIG. 8 shows a system for storing and processing a database according to the preferred embodiment.

### DESCRIPTION OF THE PREFERRED EMBODIMENT

The preferred embodiment of the present invention will now be described with reference to the accompanied figures.

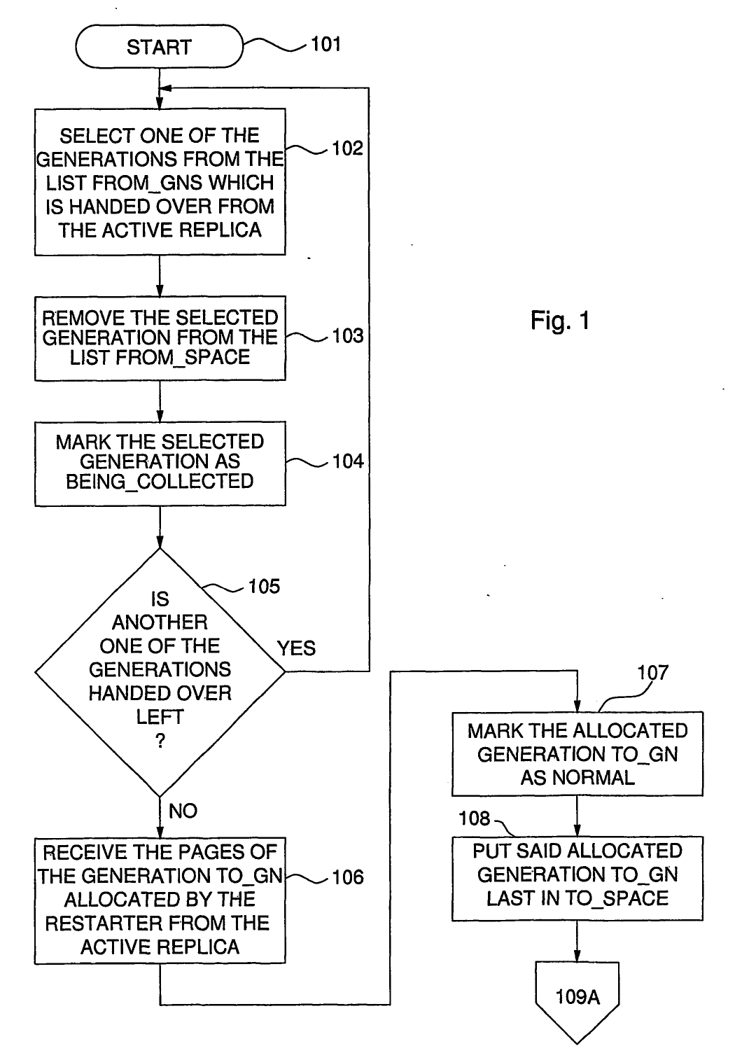

FIGS. 1 to 3 show a restart major collection step according to a preferred embodiment of the present invention. The restarting begins after the active replicas have issued a major collection begin by sending to the restarting replica the contents of the transient metadata related to generations, pages and the root block. In the restarting replica this has the effect of allocating the same generations and assigning the same pages to them as in the active replica, but with the distinction that the pages themselves are empty.

The major collection begin is issued, if a garbage collection or another collection is performed. Therefore, the restarting is included into the regular processing of the database.

The database of the preferred embodiment comprises two lists, the FROM_SPACE list and the TO_SPACE list. The FROM_SPACE list comprises generations collected during the major collection procedure, and the TO_SPACE list comprises new generations which are already collected or should not be collected during the major collection procedure. In the database of the preferred embodiment new data is inserted at the end of TO_SPACE, therefore a root pointer pointing to the last element of TO_SPACE is stored in the root block of the database. Each of the lists FROM_SPACE and TO_SPACE is ordered according to age from the youngest to the oldest generation.

For example it can be assumed that in the active replicas a few youngest generations from the list FROM_SPACE are taken to be collected into a new major generation. This new major generation is put last in fromspace, and after the collection of the generations taken has been finished, the pages of said new generation are written to a persistent memory such as a harddisk medium.

In the active replicas from time to time, for example due to a timing signal or some other reason, such a major collection step is performed, until all generations listed in the FROM_SPACE list are collected in several new mature generations. This new mature generations are stored in TO_SPACE, and because the FROM_SPACE list is empty after that, the pages of fromspace can be cleared and fromspace and tospace can be swapped so that a new mature generation from new fromspace to the new tospace can be performed. During the regular operation of the database new cells are allocated to include new contents into the database. This new cells are stored in new generations allocated in tospace. Therefore, generations with new contents are also put last in the TO_SPACE list.

When the restarting major collection step which is a step in the method for restarting a replica of said database is started in step 101 of FIG. 1 a list FROM_GNS and a pointer or address or name or such of the generation TO_GN are handed over to the procedure shown in FIGS. 1 to 3. Then, in step 102, from the list FROM_GNS which is handed over from the active replica one of the generations is selected. This generation selected is removed from the list FROM_SPACE stored in the restarting replica in step 103, and the generation selected is marked as being collected in step 104. If another one of the generations handed over is left, as probed in step 105, steps 102, 103 and 104 are repeated onto this generation.

When all generations from the list FROM_GNS have been processed in steps 102, 103 and 104, as probed in step 105, the procedure continues with step 106. In step 106 the pages of the generation TO_GN which is allocated by the restarter according to the metadata derived from the active replica are received from the active replica. Hence the generations from the list FROM_GNS are all marked as being collected, and in step 106 the contents of their cells are handed over from the active replica through a transmission line, a network or such in step 106.

In step 107 the allocated generation TO_GN which is allocated in the storage memory adapted for the replica restarting is marked as normal. Thereafter, in step 108 that allocated generation TO_GN is put last in to space. Hence, in step 106 the contents of the cells are copied into the generation TO_GN of the replica restarting. Also the generation TO_GN of the replica restarting is marked as normal (step 107) and put last in tospace (step 108). Hence, the generation TO_GN of the active replica and the generation TO_GN of the restarting replica are now identical. But care must be taken according to the pointers stored in other generations which are related to said generation TO_GN of the replica restarting.

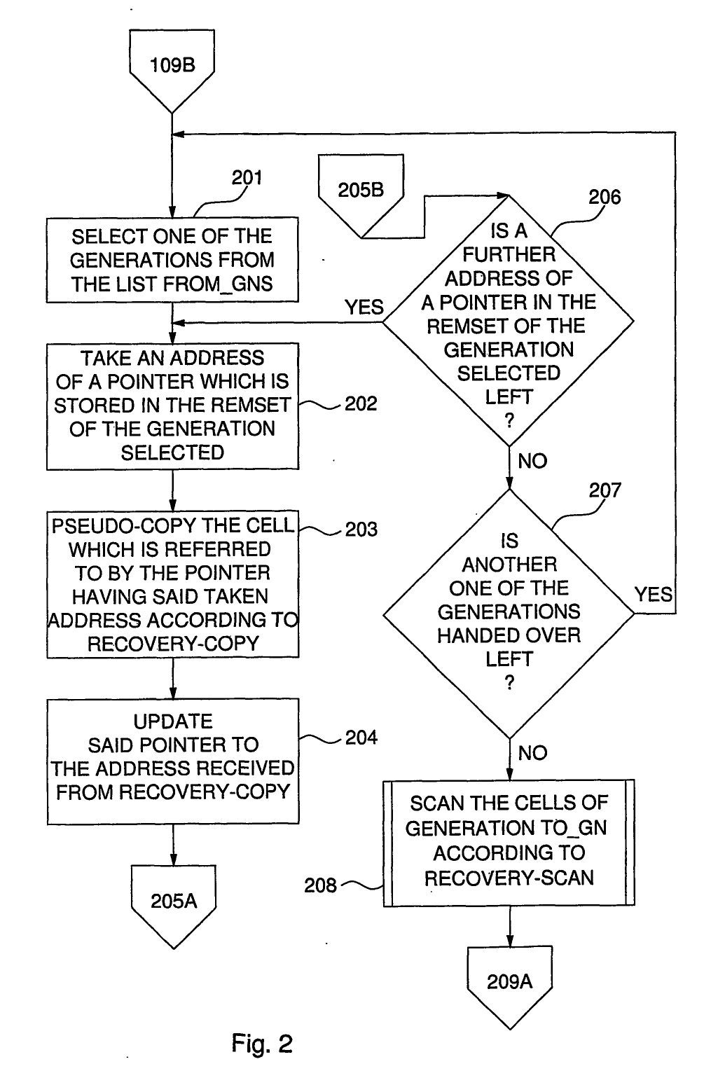

As shown by connectors 109A of FIG. 1 and 109B of FIG. 2, the procedure continues with step 201 of FIG. 2. In step 201 one of the generations from the list FROM_GNS is selected, and in step 202 an address of a pointer which is stored in the remset of the generation selected is taken. Remsets (remembered sets) are used as follows. In the beginning of a major generation collection, to each generation which should be collected in this major collection a remset is added. A remset of a generation is used to store addresses of pointers directing from younger generations into this generation. Hence, if a generation is collected all younger generations have already been collected, and therefore all addresses of pointers stored in cells of already collected generations are stored in the remset of this generation. Therefore, this pointers can be updated accordingly. Otherwise, it would be necessary to scan all younger generations for pointers which direct to cells of a generation which is collected.

While the copy routine that copied the cells in the active replica does update that pointers accordingly, the replica restarting only received the pages of the generation TO_GN, so that updating of the pointers must be done on the side of the replica restarting.

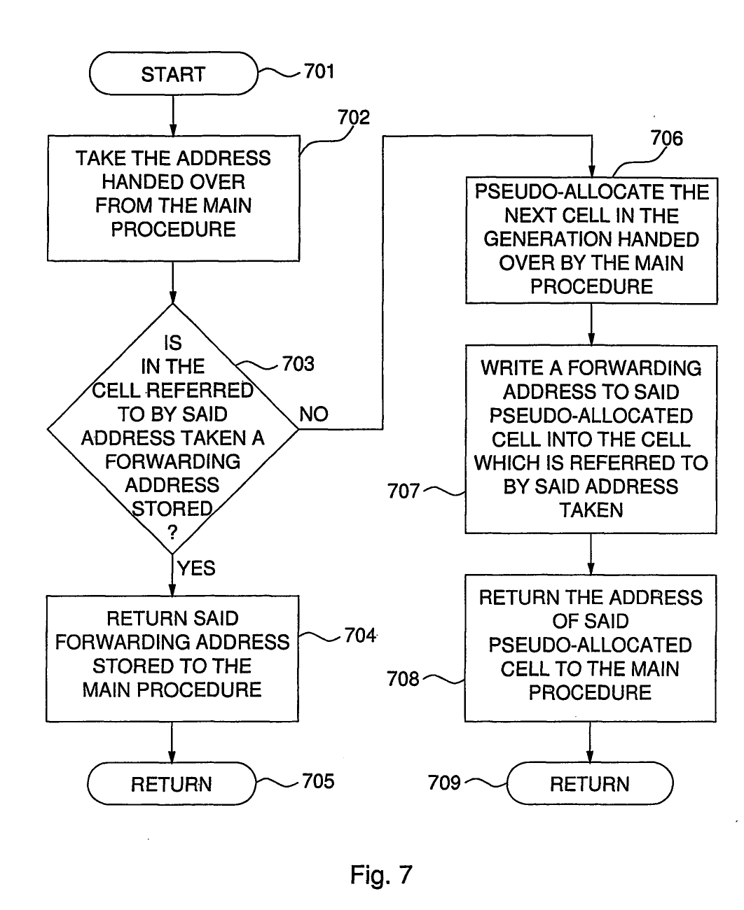

In step 203 the cell which is referred to by the pointer having that taken address (step 202) Is pseudo-copied according to recovery copy, as described in further detail according to FIG. 7. From recovery copy called in step 203 an address is received and that pointer is updated to this address in step 204. As shown by connectors 205A and 205B, the procedure continues with step 206. In step 206 it is probed, whether a further address of a pointer is stored in the remset of the generation selected from the list FROM_GNS, and if yes, the procedure repeats steps 202, 203 and 204 with regard to this further pointer until all pointers whose addresses are stored in the remset of the generation selected have been updated.

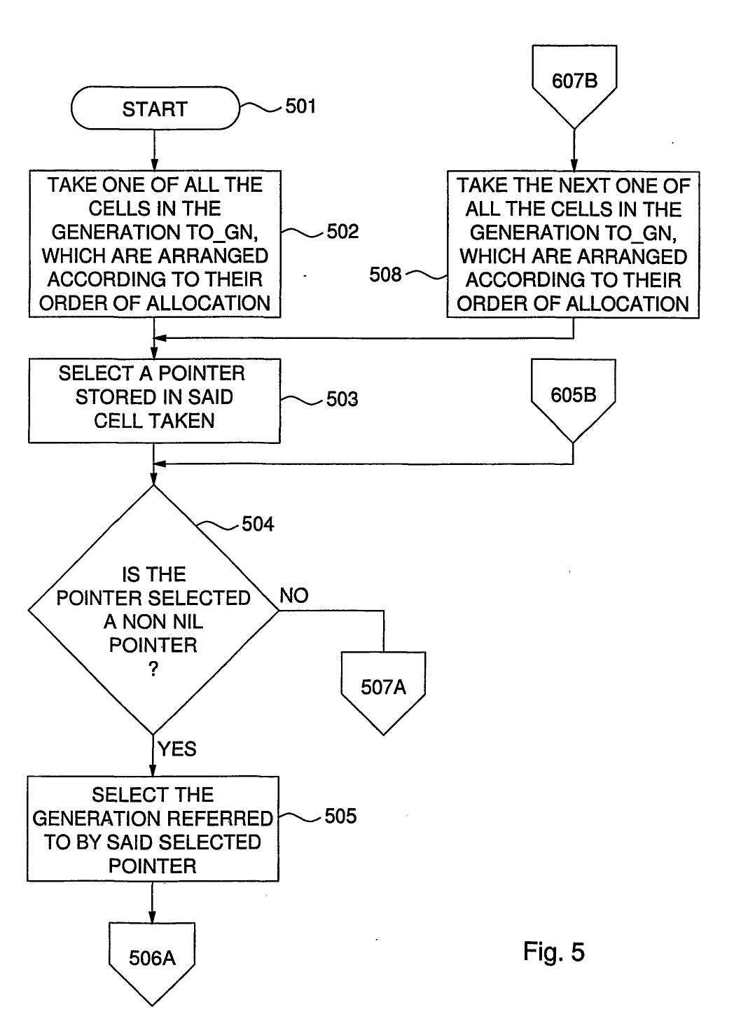

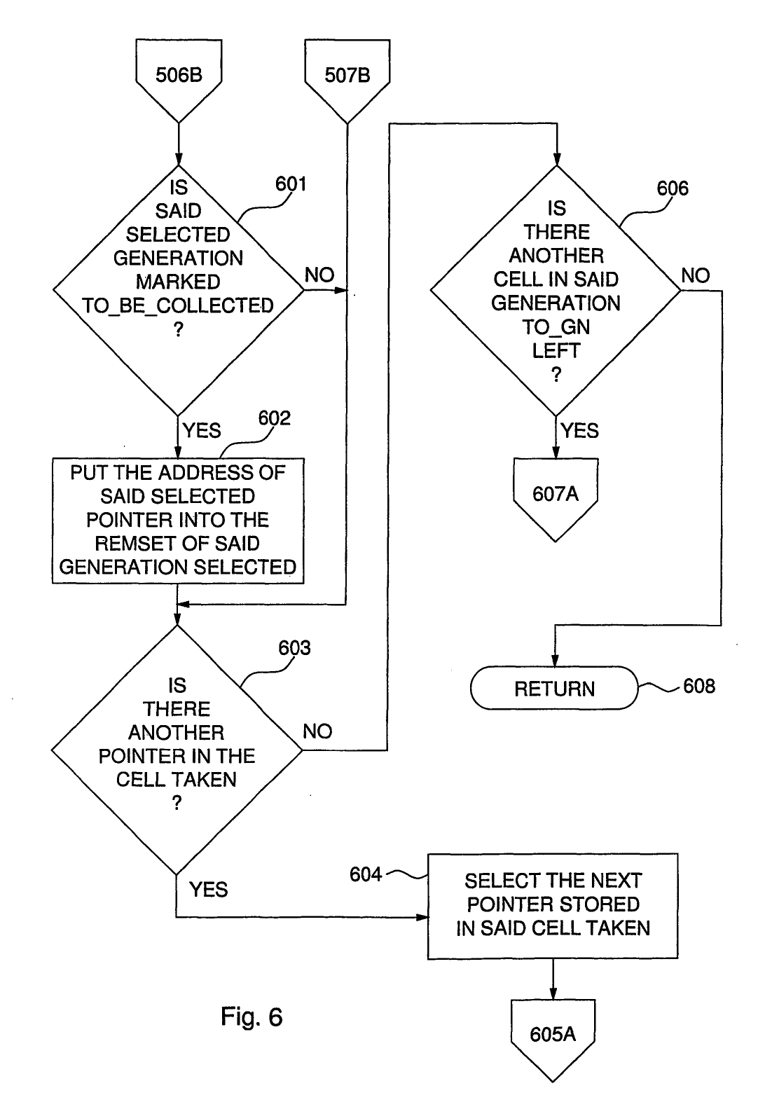

Then, as shown in step 207, in case another one of the generations handed over is left, the procedure continues with the next generation from the list FROM_GNS in step 201. Otherwise, the cells of the generation TO_GN are scanned according to recovery scan in step 208, as described in further detail according to FIGS. 5 and 6.

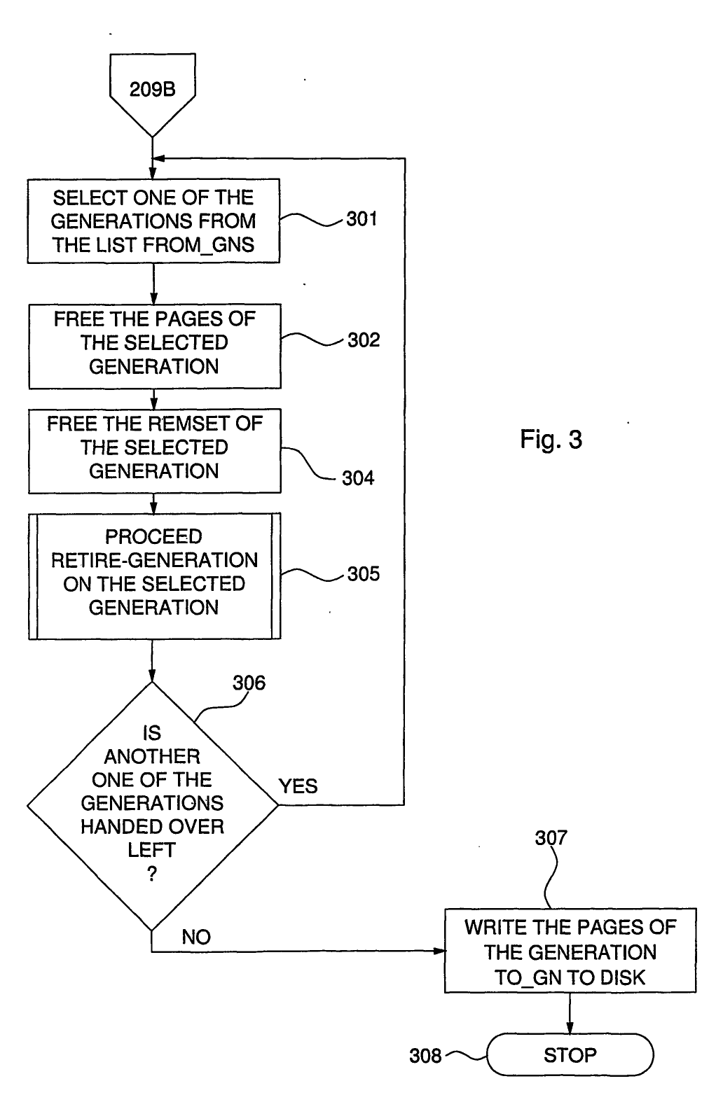

As shown by connectors 209A of FIG. 2 and 209B of FIG. 3, the procedure continues after step 208 with step 301 in which again one of the generations from the list FROM_GNS is selected. In step 302 the pages of the generation selected are freed and in step 304 the remset of the generation selected is also freed.

In step 305 the procedure retire generation is proceeded on the selected generation. To allow recovery of the database if a crash occurs in the middle of the described procedure, the generations collected into the new major generation are stored in a list OLD_FROM_SPACE. The procedure retire generation retires the generation selected to the list OLD_FROM_SPACE. In step 306 the procedure continues with step 301, if another one of the generations handed over is left in the list FROM_GNS. Hence by step 305 the former FROM_SPACE generations are retired to the set OLD_FROM_SPACE.

If the pages and remsets of the selected generations from the list FROM_GNS are freed in step 307, the pages of the generation TO_GN are written to disk. Thereafter, in step 308 the restart major collection step which collected the generations from the list FROM_GNS into the new major generation TO_GN is stopped. Thereafter, the control is handed over to the application so that further processing of the database can be performed.

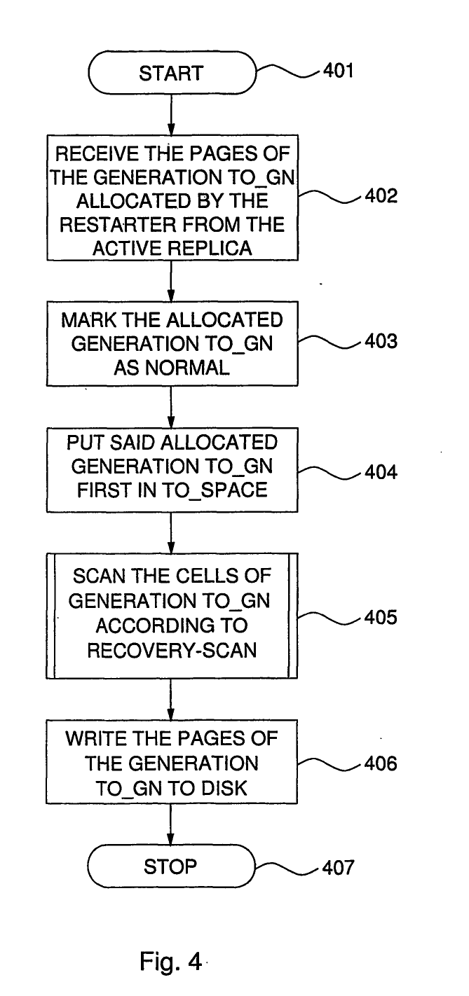

FIG. 4 shows a restart first generation collection. This collection is performed, if a first generation major collection is performed in the active replica. The first generation is the generation which is first collected into a new tospace. Hence, no younger generations to be collected exist and hence the collection is simplified.

After the restart first generation collection is started in step 401, in step 402 the pages of the generation TO_GN are received from the active replica. The restarter allocates the generation TO_GN in the memory of the replica restarting. In step 403 the allocated generation TO_GN is marked as normal, and in step 404 said allocated generation TO_GN is put first in tospace (and in the TO_SPACE list), because it is the first generation collected into it.

Although no younger generation to be collected exist, older generations to be collected exist and their remsets are filled with addresses of pointers of the first generation TO_GN collected in step 405 by the procedure recovery scan, as described in further detail according to FIGS. 5 and 6. Obviously, if the generation TO_GN is the sole generation collected during the whole major collection, the recovery scan has nothing to do.

Thereafter, the pages of the generation TO_GN are written to disk in step 406, and the restart first generation collection stops in step 407 to give control back to the main application.

FIGS. 5 and 6 show that recovery scan procedure according to the preferred embodiment of the invention. This procedure is called in step 208 of the restart major collection step, as shown in FIG. 2, and in step 405 of the restart first generation collection, as shown in FIG. 4.

After the procedure starts in step 501, one of all the cells in the generation TO_GN is taken, whereby the cells in the generation TO_GN are arranged according to their order of allocation. Hence, the cells are taken In their order of allocation from the oldest to the youngest.

In step 503 a pointer stored in said cell taken is selected, and if this pointer is a non-nil pointer, as probed in step 504, the generation referred to by this pointer selected is selected in step 505. Thereafter, as shown by connectors 506A of FIG. 5 and 506B of FIG. 6, the procedure continues with step 601. If the generation selected is marked to be collected, as determined in step 601, the address of that selected pointer is put into the remset of said generation selected in step 602.

If said selected generation is not marked to be collected, as determined in step 601, step 602 is omitted, and if the pointer selected is a nil pointer, as probed in step 504, as shown by connectors 507A of FIG. 5 and 507B of FIG. 6, step 507 and step 602 are omitted and the procedure continues directly with step 603 which is the next step after step 602.

In step 603 it is tested, whether another pointer in the cell taken exists. If another pointer exists, the next pointer stored in said cell taken is selected in step 604, and, as shown by connector 605A of FIG. 6 and connector 605B of FIG. 5, the procedure continues with step 504, until all pointers in the cell taken are processed, as probed in step 603, in which case step 606 follows.

If there is another cell in said generation TO_GN left, as tested in step 606, the procedure continues with step 508, as shown by connector 607A of FIG. 6 and connector 607B of FIG. 5. In step 508 the next one of all the cells in the generation TO_GN is taken, whereby the cells are arranged according to their order of allocation. Hence, the next younger cell is taken. Step 508 is followed by step 503.

If all cells in the generation TO_GN have been taken, and hence there is no other cell in said generation left, as probed In step 606, the procedure recovery scan returns to the main procedure in step 608.

FIG. 7 shows that recovery copy procedure according to the preferred embodiment of the invention. Said recovery copy procedure is called In step 204 of the restart major collection step procedure, as shown in FIG. 2.

When recovery copy is called in step 203 (FIG. 2) of the restart major collection step, the pointer whose address is taken in step 202 (FIG. 2) of the restart major collection step and the address or name of the generation TO_GN are handed over to the recovery copy procedure in step 701 when the recovery copy starts.

The handed over pointer refers to an address which is taken In step 702. Hence, in the preferred embodiment an address of a pointer is stored in the remset of the generation selected. This pointer is directed to a cell, and the address of this cell is the address taken in step 702.

In step 703 it is probed, whether in the cell referred to by said address taken a forwarding address is stored. If a forwarding address is stored in said cell, this forwarding address Is returned to the main procedure in step 704 and the control is given back to the restart major collection step in step 705. A forwarding address is stored in a cell, if this cell has already been copied during this or a preceding restart major collection step to avoid duplication of cells.

If the cell referred to by said address has not been copied before, and hence no forwarding address is stored in it, as determined in step 703, step 706 follows in which the next cell in the generation handed over by the main procedure is pseudo-allocated.

The pseudo-allocation simulates the behavior of the allocator used to allocate new cells in a generation. Hence, the first, second, and i^{th} issue of the pseudo-allocation procedure returns the same address as the first, second and i^{th} allocation in case the silenced replica has not been silenced. Thereby, pseudo-allocation does not modify the contents of the generation TO_GN in any way.

In step 707 a forwarding address to said pseudo-allocated cell is written into the cell which is referred to by said address taken. Thereafter, in step 708 the address of said pseudo-allocated cell is returned to the main procedure, and in step 709 the control is given back to the main procedure.

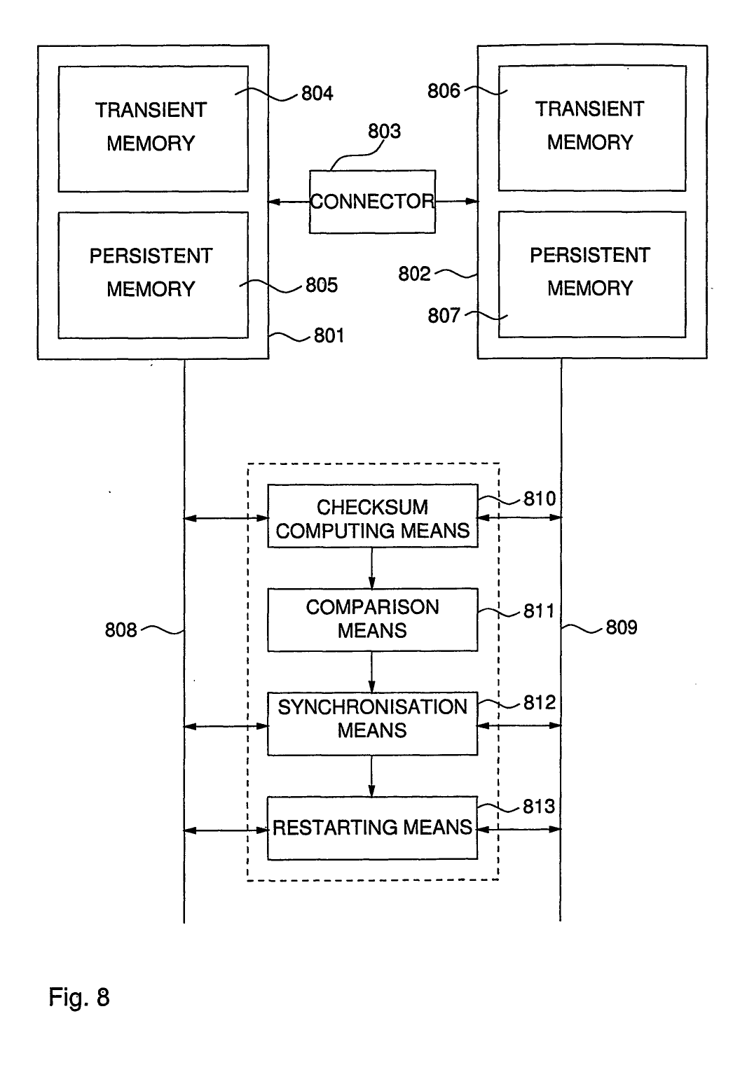

FIG. 8 shows a system for storing and processing a database according to the preferred embodiment of the invention.

The system comprises a first storage means 801 for storing a first replica of said database and a second storage means 802 for storing a second replica of said database. The first and second storage means 801, 802 are connected by a connector 803 to interchange data. Said first storage means 801 comprises a transient memory 804 and a persistent memory 805. The second storage means 802 comprises a transient memory 806 and a persistent memory 807. The transient memories 804, 806 are volatile and can be made of dynamic random access memories (DRAMs) or such. The persistent memories 805, 807 can be made of a harddisk medium or such. In the transient memories 804, 806 the transient metadata of the replicas is stored and mature generations are stored in the persistent memories 805, 807. First and second storage means 801, 802 are connected with a first 808 and second bus 809. First and second bus 808, 809 are connected with a checksum computing means 810. The checksum computing means 810 computes a checksum for each replica stored in said first and second storage means 801, 802. The checksums computed by the checksum computing means 810 are sent to a comparison means 811 to detect a difference between them. If the comparison means 811 detects a difference, a synchronization means 812 is informed. The synchronization means 812 has several non-exclusive options. For three or more replicas (not shown) one option is to vote and crash all those replicas which represent the minority opinion of the correct checksum computed by the checksum computing means 810.

If the different check sums are detected during a commit group, a second option is to abort the commit group and all transactions in it. This is achieved by making a backup of the root block before starting the commit group and restoring when aborting the group commit. Hence, neither replica stored in said first and second storing means 801, 802 needs to be restarted, and the transactions can be reattempted without significant delay. Should the failure have been caused by a transient error, the next commit group may succeed. But should also the next commit group fail, another option must be taken.

A third option is to perform a number of checks in the database. One method to make many tests in the mature generations redundant, can be the use of operating system primitives, for example to write protect mature generations during application processing. Many cell consistency checks could also be performed. incrementally, in conjunction with the copying of each cell.

Another option is to choose randomly. With a considerable probability this does not lead to an error later: the inconsistency might be caused by a failure in submitting all transaction requests in the identical order to all active replicas, or it may have been caused by a minor difference in the central processing units, such as a possible floating point division bug, or some other detectable but non-fatal failure.

This option can be taken further. Instead of immediately restarting the replica randomly chosen to be in error by the synchronization means 812, said replica can be silenced for a while. During an quaranteen time, for example for one full major collection, one of the following can happen:

The silenced replica crashes or fails a consistency check. Then the silenced replica was in error and it is restarted by said restarting means 813 according to the restarting process described with reference to FIGS. 1 to 7.

The silenced replica continues to disagree on the checksums with the primary replica, but neither seems to crash or fail a consistency check. Then it can be assumed that either replica has performed a detectable, but non-fatal failure. Then said silenced replica is restarted by the restarting means 813.

Neither replica crashes, and eventually begin to agree on checksums. Then the silenced replica can be activated again.

The primary replica crashes or fails a consistency check. In this case the silenced replica takes over and becomes the new primary replica.

When the restarting means 813 has restarted a silenced replica, the entire contents of the database except for the root block is identical in both replicas stored in the first and second 801, 802 storage means.

At this point the active replica has still hidden state which the restarter does not have, for example, buffers of incoming transactions requests and corresponding buffers in a multiplexor, wherby the multiplexor receives messages from the clients and then resents them in the same order to all replicas by using TCP/IP, which guarantees the order of the incoming messages received by the replicas. Also, all the messages still being delivered in the network are hidden states.

Therefore, the restarting means 813 sends a special message to the restarting replica so as to advice the starting replica to connect to the multiplexor. Thereafter, the multiplexor sends all new messages from clients also to the restarter. Also, the active replicas are instructed to perform a generation collection, send the resulting pages and finally the root block to the restarting replica. Then the active replicas regard the restarted replica as another active replica and exchange checksums with it.

Upon receiving the root block the restarting replica becomes an active replica and begins to read and handle incoming messages from the multiplexor and communicates with other active servers only with checksums through the checksum computing means 810 and the checksum comparison means 811.

A particular feature of the preferred embodiment of the invention is to verify replica consistency at the committing of a group of transactions. The committing can take place either due to a time period expiry or because of the filling of the generation buffer. Other committing criteria could as well be applied such as a specified amount of transactions or a specific request from a given transaction. The method works in the way that when the group commit is performed, the replica servers exchange checksums of the updates performed by the transactions within the group. If the checksums agree, the replica servers commit the transaction group and start a new transaction group. The starting of a new transaction group involves the creation of a committed generation onto the set of generations. A generation can be seen as a version of the database after a group of committed transactions. In any case, the crashed replica servers can start a recovery procedure by inspecting disk writes issued from other database servers. When they have recovered the old generations via disk writes, they can synchronise the transactions with the working replica servers. This is issued by sending a synchronisation token from the replica servers to the working replica server. At the processing of the synchronisation token, a group commit is performed and the replica servers start from identical state.

The replication algorithm is coupled with a complete major collection, i.e. the collection of all mature generations, in the active replica. If a mature collection is underway, the recovery process cannot start until the oldest mature generation has been collected.

The recovery process is started with the start of a new major collection. The passive replica(s) are sent metadata about a physical heap organization. The purpose of this step is to guarantee that all replicas have a consistent view of the page-level organization of the heap.

New transactions can be run in the active replica while the recovery process is active. After having completed a major collection, the active replica finalizes the recovery process by shipping the passive replica(s) the new mature generations (including the metadata) that were created during the recovery process.

Although exemplary embodiments of the invention have been disclosed, it will be apparent to those skill in the art that various changes and modifications can be made which will achieve some of the advantages of the invention without departing from the spirit and scope of the invention, such modifications to the inventive concept are intended to be covered by the appended claims.

1. A method for restarting a replica of a database, said method comprising the steps of:
a1) sending the transient metadata of an active replica to the replica restarting and
b) sending the contents of cells which are collected in said active replica to said replica restarting.

2. A method according to claim 1, wherein said cells send to the restarting replica are collected during a mature generation step.

3. A method according to claim 1, wherein said transient metadata comprises metadata which is related to generations and/or pages and/or the root block of the database.

4. A method according to claim 1 wherein the pages of collected generation comprising at least one cell are written to a persistent memory of the restarting replica.

5. A method according to claim 1, comprising the further step of:
a2) allocating from said transient metadata in the restarting replica the same generations as in the active replica.

6. A method according to claim 5, whereby the generations allocated in the restarting replica are allocated with empty memory pages.

7. A method according to claim 5, wherein, after the generations of the active replica have been collected the replica restarting is synchronized with the active replica, and then the replica restarting is regarded as another active replica.

8. A method for managing replicas of a database comprising the steps of:
a) computing for each replica a checksum,
b) comparing the checksums computed, and
c) synchronizing the replicas of the database.

9. A method according to claim 8, wherein a replica with a checksum different from the most frequent checksum is deleted and recovered in total.

10. A method according to claim 8, wherein said checksums are computed before the end of a group commit, whereby in case of at least two different checksums the group commit is repeated.

11. A method according to claim 8 whereby in case of at least two different checksums the regular processing of the database is halted and the database is checked.

12. A method according to claim 8 whereby in case of different checksums, a replica is chosen, said replica chosen is silenced, whereby at least one replica remains active as a primary replica, in case said active replica fails, said silenced replica becomes the new primary replica, and in case both said primary and silenced replica begin to agree on checksums the silenced replica is restarted.

13. A method according to claim 8, wherein said checksum is computed over the data in the root block of the database.

14. A method according to claim 8, wherein said checksum is computed over at least one cell or over at least one generation of the database

15. A method according to claim 8, wherein said checksum is computed from a group of transactions received to all replicas.

16. A method according to claim 15, wherein said checksum is computed on the committing of said transactions.

17. A method according to claim 16, wherein said committing of the transactions takes place due to memory arrangement procedures.

18. A method according to claim 16, wherein said committing of the transactions take place due to an expiry of a maximum allowed time period without group committing.

19. A system for storing and processing a data base comprising:
a first storage means for storing a first replica of said database and
at least a second storage means for storing a second replica of said database,
whereby said first and second storage means are connected to interchange data, and
a restarting means for restarting said first or second replica after it has been silenced,
whereby said restarting means sends the transient metadata of the active one of said first and second replicas to the silenced one and copies for each collected cell the pages of the active replica storage memory to pages of the silenced replica storage means arranged according to said metadata.

20. A system for storing and processing a database according to claim 19, characterized in that said metadata is stored in transient memories and contents of cells of the database are stored in persistent memories of said first and second storage means.

21. A system for storing and processing a database according to claim 20, characterized in that said restarting means allocates in said silenced replica storage means with regard to said metadata sent empty pages of the generations of the database stored in the active replica, and copies the contents of the pages of at least one generation, when this generation is stored into said persistent memory of the active replica storage means.

22. A system for storing and processing at least two replicas of a database comprising:
a checksum computing means for computing a checksum for each replica,
a comparison means for comparing said checksums computed, and
a synchronization means for synchronizing said replicas with regard to their checksums.

23. A system for storing and processing a database according to claim 22, characterised in that said synchronization means terminates a replica with a checksum different from the most frequent checksum.

24. A system for storing and processing a data base according to claim 22, characterised in that checksum computing means computes said checksums before the end of a group commit and said synchronization means restarts said group commit, if the comparison means detects different checksums.

25. A system for storing and processing a database according to claim 22, characterized in that said synchronization means halts the regular processing of the database and instructs a database test, if the comparison means detects different checksums.

26. A system for storing and processing a database according to claim 22, characterized in that, in case said comparison means detects different checksums, said synchronization means silences at least one replica, whereby at least another one remains active as a primary replica,
in case said active replica fails, said silenced replica becomes the new primary replica, and in case both said primary and silenced replica begin to agree on checksums the silenced replica is restarted.
